(19) United States
(12) Patent Application Publication
(10) Pub. No.: US 2022/0221157 A1
(43) Pub. Date: Jul. 14, 2022

(54) ON-DEMAND OVEN INSERT FOR AIRCRAFT GALLEY

(71) Applicant: Koninklijke Fabriek Inventum B.V., Nieuwegein (NL)

(72) Inventor: Hans Huijsing, Nieuwegein (NL)

(73) Assignee: Koninklijke Fabriek Inventum B.V., Nieuwegein (NL)

(21) Appl. No.: 17/147,050

(22) Filed: Jan. 12, 2021

(51) Int. Cl. F24C 7/08; F24C 7/10; F24C 15/30; F24C 15/16

(52) U.S. Cl. CPC F24C 7/088; F24C 15/16; F24C 15/30; F24C 7/105

(57) ABSTRACT

An oven is disclosed for preparing meals on-demand in an aircraft galley, which includes a housing having a cooking path extending between an inlet for introducing a food product into the cooking path and an outlet for retrieving the food product from the cooking path, a plurality of heating zones located along the cooking path for sequentially cooking the food product, a conveyor assembly for transporting the food product from the inlet of the cooking path to the outlet of the cooking path through the plurality of heating zones, and at least one heating element located within each cooking zone.

### BACKGROUND OF THE INVENTION

### 1. Field of the Invention

The subject invention is directed to a cooking appliance, and more particularly, to an oven insert for making on-demand meals in a galley of a passenger aircraft.

### 2. Description of Related Art

Hot meals on board passenger aircraft are typically prepared in oven inserts installed in the galley of the aircraft. These oven inserts can use steam, convection or induction for cooking meals. Currently, galley ovens used in passenger aircraft have the drawback that a plurality of meals supplied by a catering service have to be loaded into the ovens for cooking and subsequently unloaded from the ovens by the flight crew.

Loading and unloading of the ovens is very time-consuming. As a result, crew members occupied with this task are unavailable to carry out other services for the passengers for an extended period. Furthermore, when unloading of the ovens, crew members can burn themselves on hot surfaces of the ovens.

In addition, because current oven inserts used on commercial aircraft are designed for cooking many meals all at the same time and in accordance with a common heating profile, they are not well-suited for cooking individual meals on-demand in an energy efficient manner and in accordance with a unique cooking profile to create a quality meal.

The subject invention is directed to an oven insert that overcomes these drawbacks by providing a system for cooking individual food products on-demand in accordance with a predetermined cooking profile.

### SUMMARY OF THE DISCLOSURE

The subject invention is directed to a new and useful oven system, which is particularly well adapted for making on-demand meals in an automated galley installed on a commercial aircraft. The oven system includes a housing having a cooking path extending between an inlet for introducing a food product into the cooking path and an outlet for retrieving the food product from the cooking path.

There are a plurality of heating zones located along the cooking path for sequentially cooking the food product, and a conveyor assembly is provided for transporting the food product from the inlet of the cooking path to the outlet of the cooking path through the plurality of heating zones. Preferably, the conveyor assembly includes one or more conveyor belts for transporting the food product through the plurality of cooking zones.

There is at least one heating element located within each cooking zone, and the heating element is selected from the group of heating elements consisting of a resistive heating element, an inductive heating element, a ceramic heating element, a metallic heating element and a microwave heating element.

In an embodiment of the invention, the inlet of the cooking path is adjacent a top of the housing and the outlet of the cooking path is adjacent a bottom of the housing. In an embodiment of the invention, the plurality of heating zones includes heating zones that are adjacent one another within the housing. In a preferred embodiment of the invention, the plurality of heating zones includes heating zones that are vertically spaced apart from one another within the housing.

The oven system further includes a data input device for entering data relating to a predetermined cooking profile of the food product to control the at least one heating element located within each heating zone. It is envisioned that the predetermined cooking profile relates to at least one of a transport speed of the conveyor assembly, an activation time of one or more of the heating elements, and a temperature of one or more of the heating elements. In an embodiment of the invention, a fan is associated with the cooking path within the housing, and the predetermined cooking profile relates to operating parameters of the fan.

The data input device is selected from the group consisting of a bar code scanner, a QR code scanner and an RFID scanner for automatically setting the predetermined cooking profile for a particular food product. Alternatively, the data input device is a user interface for manually setting the predetermined cooking profile for a particular food product.

The oven system further includes means for sending a message that the food product is ready for serving. The means for sending a message that the food product is ready for serving can includes at least one of a visual signal indicator and an audible signal indicator. Alternatively, the means for sending a message that the food product is ready is a device that is adapted and configured to facilitate communication between the oven and a Personal Electronic Device (PED).

The subject invention is also directed to an oven for preparing meals on demand in the galley of an aircraft, which includes a housing having a cooking path extending between an inlet for introducing a plurality of food products in succession to the cooking path and an outlet for retrieving the food product from the cooking path. A plurality of heating zones is located along the cooking path and they are spaced vertically apart from one another within the housing for sequentially cooking the food product. A conveyor assembly is provided for transporting the food product from the inlet of the cooking path to the outlet of the cooking path through the plurality of heating zones, and at least one heating element is located within each cooking zone.

A data input device is also provided for entering data relating to a predetermined cooking profile of a food product introduced into the cooking path to control the at least one heating element located within each heating zone. And, a controller is provided for receiving the data relating to the predetermined cooking profile from the data input device to control heating element located within each heating zone based thereon.

These and other features of the on-demand oven of the subject invention will become more readily apparent to those having ordinary skill in the art to which the subject invention appertains from the detailed description of the preferred embodiments taken in conjunction with the following brief description of the drawings.

### BRIEF DESCRIPTION OF THE DRAWINGS

So that those having ordinary skill in the art will readily understand how to make and use the oven system of the subject invention without undue experimentation, preferred embodiments thereof will be described in detail herein below with reference to the figures wherein:

FIG. 1 is a perspective view of an on-demand oven system constructed in accordance with a preferred embodiment of the subject invention, which is shown in cross-section to illustrate a plurality of food products being transported through the cooking path in succession; and

FIG. 2 is a schematic representation of the control architecture for the on-demand oven system of the subject invention.

### DETAILED DESCRIPTION OF THE PREFERRED EMBODIMENTS

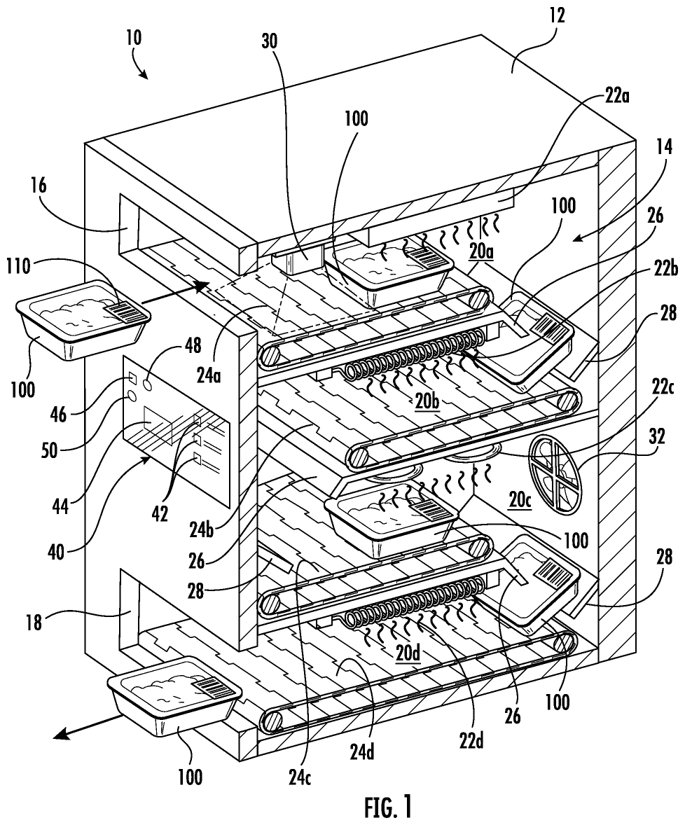

Referring now to the drawings wherein like reference numerals identify similar structural features or elements of the subject invention, there is illustrated in FIG. 1 a new and useful oven system, which is designated generally by reference numeral 10. Oven system 10 is adapted for use as a galley insert for making meals on a commercial aircraft.

More particularly, the oven system 10 can be used for making meals on-demand in an automated self-service galley installed on a commercial aircraft, where passengers could purchase a meal, for example, from a crew member or vending machine, and then prepare that meal in the oven system 10 without assistance from a crew member. Alternatively, a crew member can make meals on-demand utilizing the oven system 10 of the subject invention.

Referring to FIG. 1, the oven system 10 includes a housing 12 having a cooking path 14 extending between an inlet 16 located near the top of housing 12 for introducing food products 100 into the cooking path 14 and an outlet 18 located near the bottom of housing 12 for retrieving food products 100 from the cooking path 14. In accordance with a preferred embodiment of the subject invention, there are a plurality of heating zones located along the cooking path 14 for sequentially cooking food products 100. For example, heating zones 20a through 20d of cooking path 14.

It is envisioned that each heating zone along the cooking path 14 would be configured to perform a different function, such as for example, defrosting, preheating, grilling, cooking and/or crisping or the like, which would allow for the creation of a particular heating profile for a food product, resulting in a perfectly cooked meal. While the cooking path 14 shown in FIG. 1 includes four heating zones (20a through 20d), it is envisioned that the oven system 10 could include fewer or more than four cooking zones. The more cooking zones there are in the oven, the more meals can be cooked sequentially at the same time.

To achieve this functionality, each heating zone 20a-20d along the cooking path 14 includes one or more heating element 22. That is, there is at least one heating element located within each cooking zone 20a-20d, designated by reference numerals 22a-22d, respectively. It is envisioned that the heating element(s) in each zone could be the same type of heating elements, or one or more of the heating elements could be different from the others. The heating elements 22a-22d would be selected from a group of heating elements consisting of a resistive heating element, an inductive heating element, a ceramic heating element, a metallic heating element, an infrared heating element and/or a microwave heating element.

The oven system 10 further includes a conveyor assembly for transporting food products from the inlet 16 of the cooking path 14 to the outlet 18 of the cooking path 14 through the plurality of heating zones 20a-20d. As illustrated in FIG. 1, the conveyor assembly includes a plurality of sequentially arranged and vertically separated motorized conveyor belts 24a-24d for transporting food products 100 through the plurality of cooking zones 20a-20d. They conveyor belts 24a-24d are preferably fabricated from a heat resistant material, such as linked metal struts, chain linked wires or the like, and they are preferably driven by a mechanical drive mechanism such as a chain and sprocket assembly or belt and pulley assembly.

The cooking path 14 also includes a series of cooperating guide ramps 26 and deflector flanges 28 for directing the flow of food products 100 along the cooking path 14 from the inlet 16 to the outlet 18 in an orderly and efficient manner. More particularly, at the terminal end of each conveyor belt there is an angled guide ramp 26 that fees a meal product toward an oppositely angled deflector flange 28 located adjacent a leading edge of a successive or following conveyor belt.

The oven system 10 further includes a data input device 30 for entering data relating to a predetermined cooking profile of the food product 100 to control the at least one heating element 22 located within each heating zone 20a-20d. More particularly, the predetermined cooking profile could relate to at least one of an activation time of one or more of the heating elements 22, and/or a temperature of one or more of the heating elements 22.

It is envisioned that the predetermined cooking profile could also relate to a transport speed of one or more of the conveyor belts 24a-24d. In an embodiment of the subject invention, at least one fan 32 is associated with the cooking path 14 within the housing 12, and the cooking profile could relate to the operating parameters of the fan 32, to allow for a cooling period or the like, for example. Alternatively, the fan 32 could be used to blow hot air over a food product 100 to enhance heat transfer within one or more of the heating zones 20a-20d.

Preferably, the data input device 30 is selected from a group of devices consisting of a bar code scanner, a QR code scanner and an RFID scanner for automatically setting the cooking profile for a particular food product 100. The data input device 30 is preferably located at or near the inlet 16 to the cooking path 14, so that it can readily obtain data from a bar code label 110 on the package of the food product 100.

Alternatively, the data input device is a user interface panel 40 located on the front of the housing 12 for manually setting the cooking profile for a particular food product 100 using a set of buttons 42, for example, in accordance with an instruction set on the product packaging. The user interface panel 40 includes a graphical display 44 for presenting messages and other operating information to a user.

The oven system 10 further includes a device for sending a message that a food product 100 is ready for serving. The device for sending a message that a food product 100 is ready for serving can includes a visual signal indicator 46 associated with the user interface panel 40 or an audible signal indicator 48. Alternatively, the device for sending a message that a food product 100 is ready is an electronic device 50 (e.g., a wireless transmitter) associated with the user interface panel 40 or elsewhere in the oven system 10 that is adapted and configured to facilitate communication between the oven system 10 and a Personal Electronic Device (PED).

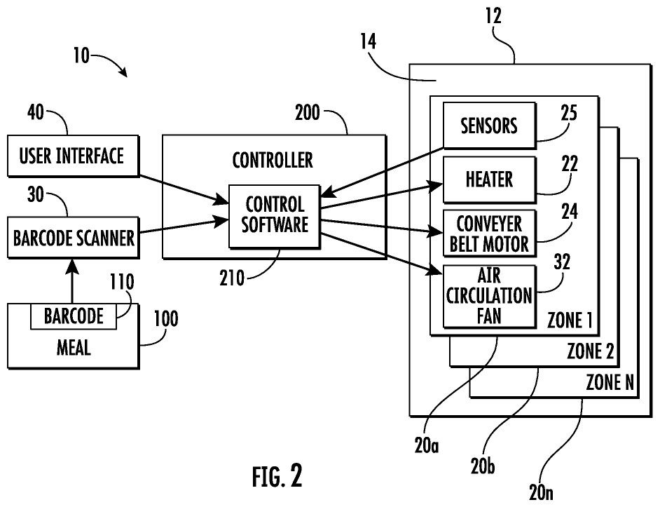

Referring now to FIG. 2, there illustrated a schematic illustration of the control architecture for the oven system 10 of the subject invention. In particular, the control architecture includes an oven controller 200 that includes programmable control electronics and associated control software 210. The control software 210 is adapted and configured to receive and process data that is input or otherwise entered through the user interface 40 relating to the cooking profile of a food product 100 or from the bar code scanner 30, which obtains data relating to a cooking profile from a barcode 110 on a food product 100.

The control software 210 of oven controller 200 is also adapted and configured to receive data or feedback from one or more sensors 25 associated with each of the multiple heating zone located within the cooking path 14 of oven system 10, for example a temperature sensor or a motor speed sensor. In addition, the control software 210 is adapted and configured to communicate control instructions to a heater element 22, conveyor belt motor 24 and air circulation fan 32 associated with each heating zone in the cooking path 14 of oven system 10.

The oven system 10 of the subject invention provides several benefits over prior art oven inserts installed on aircraft. The oven system 10 is designed for cooking a single meal in an efficient manner, rather than cooking a plurality of meals all at the same time, thus conserving power. The use of a tailored cooking profile or program for a specific food product provides for optimal cooking and high quality meals. Because of the conveyor system, there is no need to access a meal from the oven while it is hot, so there is less chance of a crew member getting a burn injury.

While the subject disclosure has been shown and described with reference to a preferred embodiment, it will be readily appreciated that changes and/or modifications may be made thereto without departing from the scope of the subject disclosure. For example, while the oven system is shown and described herein as having vertically separated heating zones, it is envisioned that the heating zones could be arranged linearly, side-by-side or in a different configuration, so long as the oven is capable of cooking meals on demand in a sequential manner based upon a predetermined cooking profile.

What is claimed is:

1. An oven for preparing meals on demand comprising:
a) a housing including a cooking path extending between an inlet for introducing a food product into the cooking path and an outlet for retrieving the food product from the cooking path;
b) a plurality of heating zones located along the cooking path for sequentially cooking the food product;
c) a conveyor assembly for transporting the food product from the inlet of the cooking path to the outlet of the cooking path through the plurality of heating zones; and
d) at least one heating element located within each cooking zone.

2. The oven recited in claim 1, wherein the inlet of the cooking path is adjacent a top of the housing and the outlet of the cooking path is adjacent a bottom of the housing.

3. The oven recited in claim 1, wherein the plurality of heating zones includes heating zones that are adjacent one another within the housing.

4. The oven recited in claim 3, wherein the plurality of heating zones includes heating zones that are vertically spaced apart from one another within the housing.

5. The oven recited in claim 1, wherein the conveyor assembly includes one or more conveyor belts for transporting the food product through the plurality of cooking zones.

6. The oven recited in claim 1, wherein the at least one heating element is selected from the group of heating elements consisting of a resistive heating element, an inductive heating element, a ceramic heating element, a metallic heating element, an infrared heating element and a microwave heating element.

7. The oven recited in claim 1, further comprising a data input device for entering data relating to a predetermined cooking profile of the food product to control the at least one heating element located within each heating zone.

8. The oven recited in claim 7, wherein the predetermined cooking profile relates to at least one of a transport speed of the conveyor assembly, an activation time of one or more of the heating elements, and a temperature of one or more of the heating elements.

9. The oven recited in claim 8, wherein a fan is associated with the cooking path within the housing, and the predetermined cooking profile relates to operating parameters of the fan.

10. The oven as recited in claim 7, wherein the data input device is selected from the group consisting of a bar code scanner, a QR code scanner and an RFID scanner for automatically setting the predetermined cooking profile for a particular food product.

11. The oven as recited in claim 7, wherein the data input device is a user interface for manually setting the predetermined cooking profile for a particular food product.

12. The oven as recited in claim 1, further comprising means for sending a message that the food product is ready for serving.

13. The oven as recited in claim 12, wherein the means for sending a message that the food product is ready for serving includes at least one of a visual signal indicator and an audible signal indicator.

14. The oven as recited in claim 12, wherein the means for sending a message that the food product is ready is a device that is adapted and configured to facilitate communication between the oven and a Personal Electronic Device (PED).

15. An oven for preparing meals on demand in a galley of an aircraft, comprising:
a) a housing including a cooking path extending between an inlet for introducing a plurality food products in succession to the cooking path and an outlet for retrieving the food product from the cooking path;
b) a plurality of heating zones located along the cooking path and spaced vertically apart from one another within the housing for sequentially cooking the food product;
c) a conveyor assembly for transporting the food product from the inlet of the cooking path to the outlet of the cooking path through the plurality of heating zones;
d) at least one heating element located within each cooking zone;
e) a data input device for entering data relating to a predetermined cooking profile of a food product introduced into the cooking path to control the at least one heating element located within each heating zone; and
f) a controller for receiving the data relating to the predetermined cooking profile from the data input device and for controlling the at least one heating element located within each heating zone based thereon.
